(19) United States
(12) Patent Application Publication
(10) Pub. No.: US 2003/0095301 A1
(43) Pub. Date: May 22, 2003

(54) Scanning method and scanning apparatus for optical density measurement

(75) Inventors: Andreas Berchtold, Wessling/Obb (DE); Thomas Schmid, Zell (DE); Armin Weichmann, Kissing (DE)

Correspondence Address: COHEN, PONTANI, LIEBERMAN & PAVANE, 551 Fifth Avenue, Suite 1210, New York, NY, 10176, US

(73) Assignee: MAN Roland Druckmaschinen AG

(21) Appl. No.: 09/851,918

(22) Filed: May 9, 2001

(30) Foreign Application Priority Data
May 11, 2000 (DE) 100 23 128.4

(51) Int. Cl. H04N 1/46

(52) U.S. Cl. 358/530

(57) ABSTRACT

The invention relates to a scanning method and a scanning apparatus for optical density measurement of preferably at least one measurement object arranged on a printing medium, with sensor means for scanning the measurement object. The invention envisages that the sensor means comprise a number of measurement heads, and that, in a manner dependent on the detection—performed by means of a selected measurement head—of a reference object arranged on the printing medium at a distance from the measurement object which is predetermined in the transport direction of the printing medium, the measurement heads which are thereupon activated detect and scan the measurement object. To that end, the measurement object is designed as a measurement strip which extends transversely with respect to the transport direction of the printing medium along the width thereof and has a linearly arranged chain of measurement fields having specific color density values. An individual measurement field of a further measurement strip can be used as the reference object.

### BACKGROUND OF THE INVENTION

1. Field of the Invention

The invention relates to a scanning method for operating a scanning apparatus for optical density measurement of at least one measurement object arranged on a printing medium, the measurement object being scanned by sensor means, and furthermore to a scanning apparatus for carrying out the scanning method.

2. Description of the Related Art

Such a scanning method and such a scanning apparatus are disclosed in the prior art, for example in DE 196 50 223 A1. In this case, for optical density measurement, the printing medium is removed from a current printing process and positioned and adjusted on a measurement table device, one or more measurement objects arranged on the printing medium being measured by means of sensors. The fact that the optical density can only be measured “offline” is unsatisfactory in this case.

### SUMMARY OF THE INVENTION

Accordingly, the object consists in providing a scanning method of the type mentioned in the introduction and a scanning apparatus serving to carry out this scanning method, whereby, in a relatively time-saving manner, it is possible to carry out a density measurement which is selected at the location of the measurement object to be scanned and can also be used for “online” measurement purposes.

The object is achieved in respect of the method by virtue of the fact that the measurement object is scanned in a manner dependent on the detection of the position of a reference object, arranged on the printing medium, and the relative position of the measurement object with respect to the reference object.

What is characteristic of the scanning method according to the invention is the detection of the reference object and the control—defined thereby—of the scanning of the measurement object, with the result that the scanning method can be used “online” or “inline”, that is to say during the current printing process.

During normal operation of the printing process, i.e. when the transport speed of the printing medium is approximately constant, a variant of the scanning method according to the invention may consist in the fact that scanning which is activated with a time delay relative to the instant of detection of the reference object is triggered according to the currently determined speed of the printing medium and the distance between the reference object and the measurement object, said distance running in a predetermined manner in the transport direction of the printing medium. In this case, a temporal reference system is present in the printing direction,

In respect of the apparatus, the object specified above is achieved, in the case of a scanning apparatus having at least one measurement object arranged on a printing medium and having sensor means for scanning the measurement object, by virtue of the fact that the sensor means comprise a number of measurement heads, and that, in a manner dependent on the detection—performed by means of at least one selected measurement head—of at least one reference object arranged on the printing medium at a predetermined distance from the measurement objects, the measurement heads which are thereupon activated scan the measurement object. The scanning apparatus can thus be used in particular for so-called “inline” measurements, i.e. measurements in the current printing process.

An advantageous development of the invention may consist in the fact that the measurement object is designed as a measurement strip which extends, in its longitudinal extent, approximately along a coordinate direction running transversely with respect to the transport direction of the printing medium, said measurement strip having a linearly arranged chain of measurement fields having specific color density values, each of the measurement heads being assigned at least one measurement section for the purpose of detection and scanning, with the result that precise and calibratable density measurement can thereby be carried out. To that end, the same or a further measurement strip can also be used for the reference measurement by at least one measurement field of the measurement strip being provided as the reference object.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a simplified, substantially end view of an embodiment of the scanning apparatus according to the invention, which is arranged, in a manner that allows it to move translationally transversely with respect to the transport direction of a printing medium, above a measurement roll of a printing machine, said roll deflecting the printing medium, the scanning apparatus having a number of measurement heads for detecting at least one reference and measurement object applied on the printing medium;

FIG. 2 shows a partial plan view of an embodiment of a measurement object, arranged transversely with respect to the transport direction of the printing medium, for optical density measurement, the measurement object being designed as a measurement strip with measurement fields arranged sequentially therein and having specific color density values;

FIG. 3 shows a side view of a further embodiment of the scanning apparatus accommodated in the printing machine and having a control electronics device provided for processing the measured values acquired by the scanning apparatus and for controlling the scanning apparatus; and

FIG. 4 shows a schematic sketch of the control electronics device which belongs to the scanning apparatus according to the invention, is provided for connection to a data processing system and has a plurality of input/output interfaces for receiving measured values and outputting control signals.

### DETAILED DESCRIPTION OF THE PRESENTLY PREFERRED EMBODIMENTS

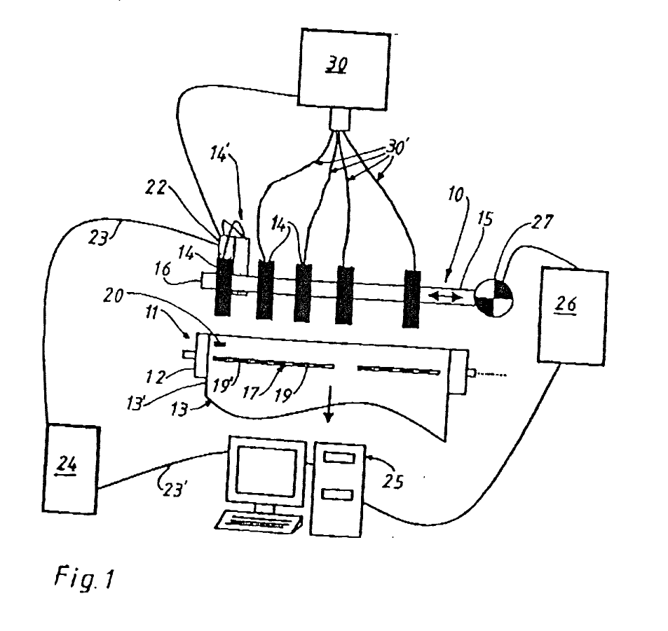

FIG. 1 illustrates the scanning apparatus 10 according to the invention in a first embodiment, which, during a current printing process, serves for densitometric measurement of a printing medium 13, such as, for example, printed or paper webs or printed sheets, which is transported via a roll 12 accommodated in a printing machine 11. To that end, the scanning apparatus 10 comprises an arrangement of measurement heads 14 which, in the exemplary embodiment, are arranged such that they are spaced apart essentially equidistantly from one another, this arrangement of measurement heads 14 being mounted on a slide device 15 mounted in a displaceable manner on a guide rail 16. The guide rail 16 extends together with the slide device 15 transversely with respect to the transport direction of the printing medium 13 and is mounted above the roll 12—serving as measurement roll—of the printing machine 11, to be precise parallel to the cylinder axis thereof, with the result that the scanning apparatus 10 is displaceable by means of the slide device 15 transversely with respect to the transport direction and thus along the width of the paper web 13 guided via the roll 12. In this case, in the exemplary embodiment, a measurement object 17 designed as a measurement strip is applied on the printing medium 13, that is to say the printed sheets or printed webs, for the purpose of optical density measurement, the measurement strip 17 comprising a linearly arranged row of measurement fields 19 and extending transversely with respect to the transport direction, i.e. in the direction of the width of the printing medium 13. Each of the measurement fields 19 in each case has a specific color density value. In order to initialize the scanning apparatus 10 according to the invention, a position marker is arranged as a reference object 20 on the printing medium 13 before and at a distance from the measurement strip 17, said distance being predetermined in the transport direction, in which case, in order to detect the reference object 20, a further measurement head 14′ is provided in the exemplary embodiment, said further measurement head being arranged downstream relative to the rest of the measurement heads 14 with respect to the coordinate axis defined by the transport direction; the detection of such a position marker 20 by means of the assigned measurement head 14′ effects a trigger signal of a trigger unit 22 which is accommodated in the scanning apparatus 10 and is arranged adjacent to the measurement head 14′ provided for the reference measurement; the trigger signal is fed via an electrical lead 23 to a control electronics device 24 and processed, after which the processed signal is communicated via a further electrical lead 23′ to a data processing system 25. A position controller device 26 which is electrically operatively connected to the data processing system 25 is driven in interaction with a control program implemented in the data processing system 25, which position controller device displaces the scanning apparatus 10 transversely with respect to the printing direction and, in a manner dependent on the reference object, measures this by means of a measurement head 14′ with regard to the optical density. The relative position—measured in parallel therewith by means of a position measurement transmitter 27 fitted in the scanning apparatus 10—of the slide device 15 orthogonally with respect to the transport direction of the printing medium 13 and also the measured density profile are used to determine the position of the measurement objects orthogonally with respect to the transport direction.

The translational displacement of the scanning apparatus 10 by means of the slide device 15 is effected using the position of the printed measurement objects and also the position of the reference object in such a way that, in a manner coinciding with the measurement strip 17 leading in at the location of the measurement roll 12, the slide device 15 of the scanning apparatus 10 was brought to the desired position in the direction of the width. The measurement strip 17 entrained on the printing medium 13 running through can thus be detected at the desired positions by the measurement heads of the scanning apparatus 10. Each of the measurement heads 14 provided for density measurement in each case measures assigned measurement sections 19′ on the measurement strip 17, i.e. each of the measurement heads 14 provided for density measurement is guided by the slide device 15 over the measurement section 19′ respectively assigned to it. In the exemplary embodiment, a measurement section 19′ accommodated in a measurement strip 17 comprises two measurement zones 19″, each individual measurement zone 19″ comprising measurement fields 19 having different color density values. In order to improve the measurement accuracy, the scanning apparatus 10 has a flash exposure unit 30, which comprises a light source and a plurality of optical fibers 30′ corresponding to the number of measurement heads, the measurement light emitted by the light source being fed optically via a respective optical fiber 30′ to a corresponding measurement head. Each measurement head which is optically operatively connected via the respective optical fiber 30′ to the flash exposure unit 30 receives a measurement light pulse for the time duration of the scanning operation, so that the measurement fields 19 to be scanned in each case are illuminated sufficiently and in a defined manner. The control unit 24 drives the flash exposure unit 30 and also triggers the scanning operation of the measurement heads 14.

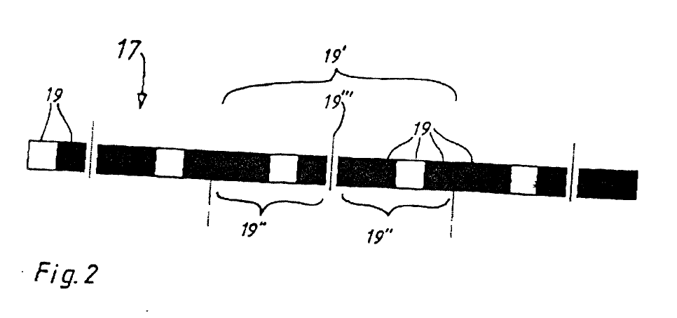

FIG. 2 shows, in a partial view, an exemplary embodiment of the measurement strip 17, which is applied on the printing medium 13 approximately transversely with respect to the transport direction of the printing medium 13. In a manner corresponding to the number of measurement heads 14 encompassed by the scanning apparatus 10 according to the invention, the measurement strip 17 has a multiplicity of measurement zones 19″ arranged one after the other, said zones being designed identically in the exemplary embodiment. To that end, in the exemplary embodiment, each measurement zone 19″ in each case comprises four measurement fields 19, each measurement field 19 having a specific color density value. Each measurement head 14 is in each case assigned two adjacent measurement zones 19″, these two measurement zones 19″ being separated from one another by a centrally interposed narrow track 19′″. In a measurement cycle, both the defined measurement fields and the density of the track are measured. As a result, a change in position of the measurement strip and also a possible contraction are detected and taken into account in the positioning of the measurement heads transversely with respect to the transport direction of the printing medium.

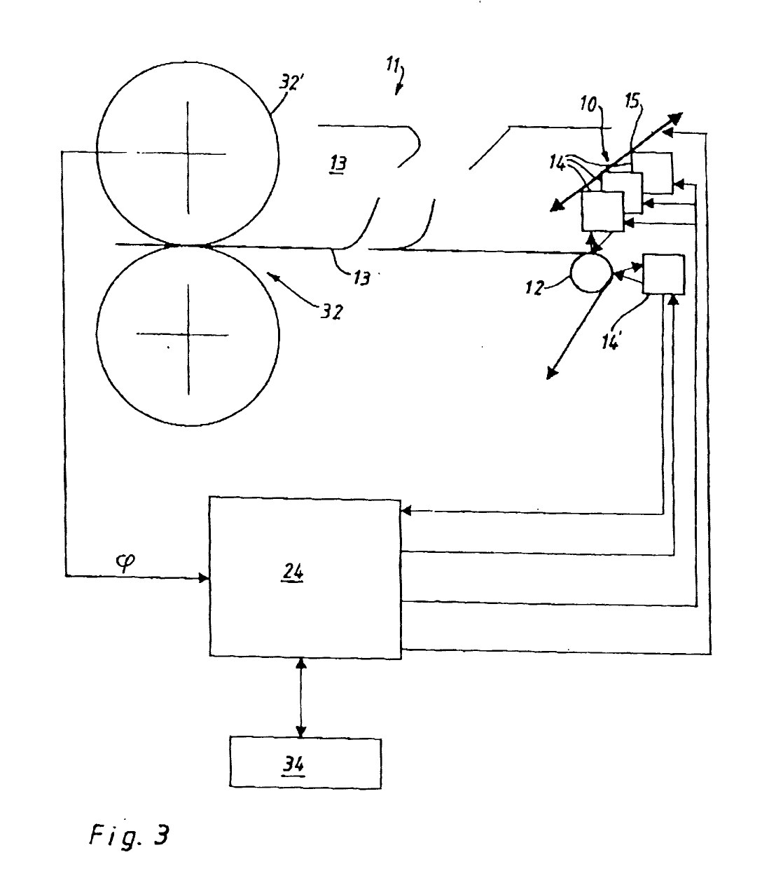

FIG. 3 shows, in a diagrammatic illustration, a further embodiment of the scanning apparatus 10 according to the invention. In this case, the printing medium 13, such as e.g. a paper web, is guided through a printing unit 32 of the printing machine 11 and deflected via a measurement roll 12. As in the first embodiment, this embodiment of the scanning apparatus 10, which is likewise arranged above the measurement roll 12, comprises a number of equidistantly arranged measurement heads 14 for detecting the measurement strip 17, the scanning apparatus 10 being displaceable by means of the slide device 15 along the cylinder axis of the measurement roll 12. As in the first embodiment, a separate measurement head 14′ for detecting a position marker provided as the reference object 20 is arranged in a stationary manner in the direction of rotation of the measurement roll 12 relative to the scanning apparatus 10. All of the measurement heads 14, 14′ are electrically operatively connected to a control electronics device 24. Furthermore, by means of a measured-value transmitter which is provided on one of the printing rolls 32′ encompassed by the printing unit 32 and detects the current angular position φ of the printing roll 32′, said control electronics device 24 continually receives the current angular-position measured value φ and processes it. On the one hand, as a result of the detection of the reference object or the position marker 20 by means of the assigned measurement head 14′, the position of the reference object is determined with regard to the angular position φ of the crucial printing roll; on the other hand, using the position of the reference object and the current angular position φ, the control electronics device 24 triggers the scanning of the measurement fields and also prescribes the search window for detecting the reference object itself. The measurement heads 14, the flash unit 30 and also the slide device 15 receive from the control electronics device 24 trigger and actuating signals for the scanning of the measurement fields and also for the performance of the movement extending transversely with respect to the transport direction. By means of a process control station 34 which is electrically operatively connected to the control electronics device 24, on the one hand measurement data obtained in the control electronics device 24 can be called up and at the same time visually displayed, and on the other hand data can be fed into the control process proceeding there.

Consequently, for the embodiments illustrated in FIGS. 1 and 3, the following functional principle emerges for the triggering on which the scanning method according to the invention is based; the triggering is effected in a manner dependent on the measured-value transmitter which is provided on the printing roll 32′ and is designed as a rotary transmitter or angle transmitter and, on account of the predetermined distance between measurement object 17 and reference object 20, can be precisely synchronized with the location of the reference object 20 and of the measurement object 17, said location being located in the transport direction of the printing medium 13, with the result that the value—determined by means of the measured-value transmitter—of the angle φ of the printing roll 32′ is a measure of the position of the measurement object 17 in relation to the location of the reference object 20. The measurement head 14′ provided for detection of the reference object 20 receives, from the control electronics device 24, a location window which is derived from the angle transmitter and the possible angular position of the reference object and within which the measurement head 14′ searches for the reference object 20. When a reference object 20 is detected, the measurement head 14′ communicates a corresponding signal to the control electronics device 24, the control electronics device 24 interrogating and storing the temporally corresponding value of the angle φ and using a filter algorithm to determine the current angular position of the reference object, said angular position being crucial for the further actions. In parallel therewith or in a temporally decoupled manner, when the trigger angle φ_{T} is reached, said trigger angle being calculated taking into account the printing roll radius and being in a functional relationship with the angular position of the reference object and the distance between reference object 20 and measurement object 17 and thus serving as a window for detecting the measurement object 17 provided for the density measurement, the control electronics device 24 triggers a trigger signal to the flash unit and the measurement heads, after which the flash unit together with the measurement heads measures the density of the respective measurement object. During the scanning operation, each measurement head 14 detects, within the measurement zones 19″ respectively assigned to it, an interposed track 19′″ in accordance with FIG. 2. The measurement of the respective tracks 19′″ allows calibration of the measurement head positions transversely with respect to the transport direction. Consequently, this triggering principle can advantageously be used as early as during the run-up of the printing machine 11, when the transport speed is not yet constant. In addition, this triggering method can advantageously be used during the run-up when the reference object cannot yet be detected but the position of the measurement objects is known.

An alternative triggering variant of the scanning method according to the invention has the following functional principle: the triggering is effected in a manner dependent on the detection of a reference object 20 by the measurement head 14′ provided therefor; since the distance between reference object 20 and measurement object 17 is predetermined in the transport direction and is stored in the control electronics device 24, when a reference object 20 is detected, the control electronics device 24 triggers a trigger signal to the scanning apparatus 10, said trigger signal being time-delayed relative to this event, after which the scanning apparatus 10 performs its translational displacement movement and scans the measurement object 17 leading in at the measurement location, i.e. at the location of the measurement roll 12. In this case, the time delay of the trigger signal is in functional dependence on the predetermined distance between reference object 20 and measurement object 17 and the continually determined transport speed of the printing medium 13 in the printing machine 11. This triggering variant can preferably be used during normal operation or the production run phase of the printing machine 11, when the transport speed assumes an approximately constant speed value.

In both triggering variants, it may be provided that the trigger signal is continually corrected in accordance with the paper stretch between the location of the angular-position measured-value transmitter and the density measuring location, by scanning a reference object 20 or a position marker on the paper web 13 in the vicinity of the measurement location. In order that a reference object which is printed with low optical density on the printing medium 13 can also be reliably detected, the trigger signal can be corrected by analog or digital filtering. In order to prevent reference-object-like elements on the printing medium 13 from being undesirably detected as reference objects 20, it is possible to define a search or positional window for the reference object 20, whose position is determined relative to the trigger signal. The search window is opened before the expected passage of the reference object 20 and is closed after the detection of the reference object 20. Furthermore, the reference object 20 used may also be, for example, an individual measurement field 19 of a measurement strip 17 provided for the density measurement. Finally, register marks can also be used as reference objects 20.

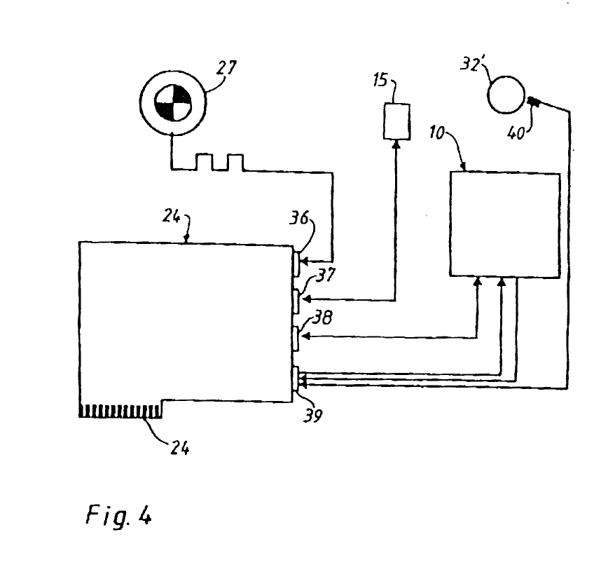

FIG. 4 shows a concrete configuration of the control electronics device 24, which is designed as a PC plug-in board with a plug connector 24′ for a corresponding interface of a personal computer as process control station 34. The control electronics device 24 has a plurality of input/output interfaces 36, 37, 38, 39, of which a first interface 36 is electrically operatively connected to the position measurement transmitter 27—assigned to the position controller device 26 of the scanning apparatus 10—for determining the relative position of the slide device 15 with regard to the coordinate axis oriented transversely with respect to the transport direction of the printing medium 13, the position measurement transmitter 27 preferably being designed as an incremental transmitter with zero index. A second interface 37 is provided for translational movement actuation of the scanning apparatus 10 and is designed as a serial RS422 interface in the exemplary embodiment, while a third interface 38 serves for densitometric measurement-value acquisition by the measurement heads 14 and, owing to the higher data transfer rate thus necessary, is designed as a serial RS422 interface, and, furthermore, a fourth interface 39 on the one hand serves for measured-value acquisition both of the measured-value pick-up 40 arranged on the printing roll 32′ for the purpose of recording the angular position, and of the measurement head 14′ provided for detecting the reference object, and on the other hand is provided for communicating trigger signals to the measurement heads 14, 14′.

The scanning method according to the invention can be used for adjusting or calibrating the measurement heads, in which case, for exact positioning of the measurement heads 14 relative to the measurement fields 19 or measurement zones 19″, a measurement field 19 is identified transversely with respect to the transport direction of the printing medium 13 by an assigned measurement head 14 being progressively moved and a density maximum or density minimum being sought. Since the measurement roll 12, which, incidentally, can also additionally fulfil the function of a cooling roll, is arranged downstream of a drier device of the printing machine 11, using the position and/or spacings of the individual tracks 19′″ determined by measurement it is possible to compensate for possible shrinkage of the paper by adjusting the measurement-head spacings. The measurement strip 17 can be printed as a printed image on the printing medium 13.

Furthermore, it may be provided that, for determining the position of the measurement objects 17, a plurality of reference objects 20 are provided which are arranged at least transversely with respect to the printing direction. As a result, normally occurring transverse contraction of the printing medium 13 can be taken into account in a compensatory manner in the positioning of the sensor means. In this case, in a manner dependent on the position of the reference object 20, the distance between the reference object 20 and the measurement object 17 and the position of a printing object and also the state of the reference system, the sensor means can be positioned in the transverse direction in such a way that the transverse position is then set to the desired position when the measurement objects pass the sensor means. Machine parameters such as, for example, the angular position of a printing roll (printing direction) or the distance from the center of the machine (transverse direction) are provided as reference system for the position of the reference object 20. Accordingly, on the one hand the reference object 20 can be detected and on the other hand the measurement object 17 can be scanned in a manner temporally decoupled from the absolute position—referring to a position sensor—of the measurement object 17. In order to be able to perform density measurements even during the run-up of the printing process, i.e. when the reference object cannot yet be identified, it is the case that, given a suitable size of the measurement objects, recourse is had to known, stored positions of reference objects.

The scanning method and the scanning apparatus can also be used for color or spectral measurement.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A scanning method for operating a scanning apparatus for optical density measurement and/or color or spectral measurement of at least one measurement object arranged on a printing medium, comprising
detecting a position of a reference object on the printing medium; and
scanning the measurement object with a sensor means based on a relative position of the measurement object with respect to the detected position of the reference object.

2. The scanning method according to claim 1, wherein the sensor means is moved in a translational movement thereof to scan said measurement object, sensor means movement being activated responsive to a detection of the reference object.

3. The scanning method according to claim 2, wherein the printing medium is carried on a roll, at an instant of detection of the reference object, a corresponding angle φ of rotation of said roll being measured and stored.

4. The scanning method according to claim 3, wherein an angle-of-rotation increment is calculated based on a diameter of said roll, the measured angle φ of rotation and a predetermined distance running in a printing medium transport direction between the reference object and the measurement object, the measurement object being scanned when said roll has rotated said angle increment.

5. The scanning method according to claim 1, wherein scanning which is activated with a time delay relative to an instant of detection of the reference object is triggered in accordance with a currently determined printing medium speed and a predetermined distance running in a printing medium transport direction between the reference object and the measurement object.

6. A scanning apparatus for optical density measurement and/or color or spectral measurement of a measurement object arranged on a printing medium, comprising:
sensor means, said sensor means including a plurality of measurement heads, said printing medium having a detection object arranged thereon at a predetermined distance running in a printing medium transport direction from said measurement object, at least one of said measurement heads being operative to detect said reference object, remainder ones of said measurement heads being activatable to detect and scan said measurement object, said remainder ones of measurement heads being activated responsive to said reference object detection.

7. The scanning apparatus according to claim 6, wherein said measurement object is a longitudinal measurement strip disposed along a coordinate direction approximately transversely of the printing medium transport direction.

8. The scanning apparatus according to claim 7, wherein the measurement strip includes a linearly arranged chain of measurement fields thereon, said measurement fields having specific color density values.

9. The scanning apparatus according to claim 8, wherein for detection and scanning purpose, each measurement head is associated with at least one measurement section, which measurement section includes measurement fields.

10. The scanning apparatus according to claim 9, wherein each measurement section comprises two adjacent spaced apart measurement zones intervened by a narrow track.

11. The scanning apparatus according to claim 10, wherein the measurement zones each have identically recurring sequences of color density values.

12. The scanning apparatus according to claim 10, wherein each measurement zone has measurements fields of a same longitudinal dimension.

13. The scanning apparatus according to claim 11, wherein each measurement zone has measurement fields of a same longitudinal dimension.

14. The scanning apparatus according to claim 13, wherein each measurement zone includes a common number of measurement fields.

15. The scanning apparatus according to claim 10, wherein each measurement zone has at least one minimum and one maximum color density value.

16. The scanning apparatus according to claim 8, wherein at least one of said measurement fields comprises the reference object.

17. The scanning apparatus according to claim 7, wherein said measurement heads are arranged one after another along said coordinate direction, the measurement heads being moveable along said coordinate direction.

18. The scanning apparatus according to claim 17, wherein the apparatus is disposed above the printing machine roll, the printing medium being carried on said roll.

19. The scanning apparatus according to claim 17, further comprising a slide device, said measurement heads being carried on said slide device, said slide device being moveable translationally along said coordinate direction.

20. The scanning apparatus according to claim 18, further comprising a slide device, said measurement heads being carried on said slide device, said slide device being moveable translationally along said coordinate direction.

21. The scanning apparatus according to claim 19, wherein in progressive time with slide device translational movement, each measurement head scans a measurement section on said measurement strip associated with said each measurement head.

22. The scanning apparatus according to claim 6, wherein the printing medium is carried on a printing roll, said apparatus further comprising an angle measurement transmitter carried on said printing roll for detecting an angle of rotation of said printing roll, said transmitter being electrically operatively connected to the apparatus.

23. The scanning apparatus according to claim 22, further comprising a control electronics unit, said control electronics unit being operative to detect a current angle of rotation of said printing roll at detection of said reference object and trigger activation of apparatus scanning when a predicted angle-of-rotation increment relative to that at detection is reached.

24. The scanning apparatus according to claim 22, further comprising a control electronics unit, said control electronics unit triggering activation of said scanning apparatus with a predicted time-delay signal, the time delay being functionally dependent on a predetermined distance between the reference object and the measurement object.
